(19) United States
(12) Patent Application Publication
(10) Pub. No.: US 2003/0188172 A1
(43) Pub. Date: Oct. 2, 2003

(54) Computer device with remote control module

(76) Inventor: Chao-Hsiung Yeh, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/096,433

(22) Filed: Mar. 13, 2002

(51) Int. Cl. H04L 9/32

(52) U.S. Cl. 713/189

(57) ABSTRACT

A computer device is provided with a remote control signal reception module, and is provided with a wireless peripheral that is equipped with a remote control switch and a power switch remote control signal generator. The remote control signal reception module in the computer is adapted to receive a power switch remote control signal from the power switch remote control signal generator of the wireless peripheral and uses the received power switch remote control signal to control the power supply condition of a power supply device of the computer. The power switch remote control signal generator may be otherwise provided on an independent wireless remote control unit.

### BACKGROUND OF THE INVENTION

1. Field of the Invention

The present invention relates to an apparatus for controlling a power supply to a computer device, and more particularly to a computer device with remote control module.

2. Description of the Prior Art

A computer usually has a plurality of peripherals connected thereto, including for example a keyboard, a mouse, a scanner, etc. Nowadays, with advanced computer technologies, many of these peripherals have been developed with wireless communication technology to provide, for example, wireless keyboard, wireless mouse, wireless network, etc. Nevertheless, actuation of all these peripherals is controlled through the computer. For instance, a printer electrically connected to the computer will be powered on only when there is a printing work to be done. Currently, most of the computers are equipped with an energy-saving mode. That is, when the computer is not in use over a predetermined period of time, it will enter into the energy-saving mode to automatically turn off the screen, the central processing unit (CPU), the hard disk, etc. However, such energy-saving mode is usually set up through a certain type of software or in the Basic Input Output System (BIOS) and can be found only on considerably new generations of computers or peripherals. In the event the computer is powered off instead of entering into the energy-saving mode, a user has to manually power on the computer again and cannot actuate the computer from the peripherals, such as the keyboard or the mouse.

To solve the above problem, a computer device with remote control module is needed, so that a user may remotely control the power-on and the power-off of the computer device from a peripheral thereof.

### SUMMARY OF THE INVENTION

A primary object of the present invention is to provide a computer device with remote control module, so that a user may remotely control the power-on and the power-off of the computer device.

Another object of the present invention is to provide a wireless computer peripheral device adapted to remotely control the power supply to a computer device. To achieve this object, the wireless computer peripheral is provided with a remote control switch for transmitting a power-on signal, and the computer device is provided with a power switch control circuit for receiving the power-on signal from the remote control switch to control the power supply to the computer device.

A further object of the present invention is to provide a wireless computer peripheral with a remote control function, wherein the wireless peripheral includes a cipher setting means for a user to set a cipher for remotely powering on a computer device.

To achieve the above objects, in accordance with the present invention, there is provided a computer device provided with a remote control signal reception module and a wireless peripheral that is equipped with a remote control switch and a power switch remote control signal generator. The remote control signal reception module in the computer is adapted to receive a power switch remote control signal from the power switch remote control signal generator of the wireless peripheral and uses the received power switch remote control signal to control the power supply condition of a power supply device of the computer. The power switch remote control signal generator may be otherwise provided on an independent wireless remote control unit.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view showing a relative positions of a wireless mouse and a computer device according to a first embodiment of the present invention;

FIG. 2 is an exploded perspective view of the wireless mouse of FIG. 1;

FIG. 3 is a control circuit diagram of the wireless mouse having a remote-control function of the first embodiment of the present invention;

FIG. 4 is a control circuit diagram for the computer end of the first embodiment of the present invention;

FIG. 5 is a perspective view showing a relative positions of a wireless mouse and a computer device according to a second embodiment of the present invention; and

FIG. 6 is a control circuit diagram of the wireless mouse having a remote-control function of the second embodiment of the present invention.

### DETAILED DESCRIPTION OF THE PREFERRED EMBODIMENTS

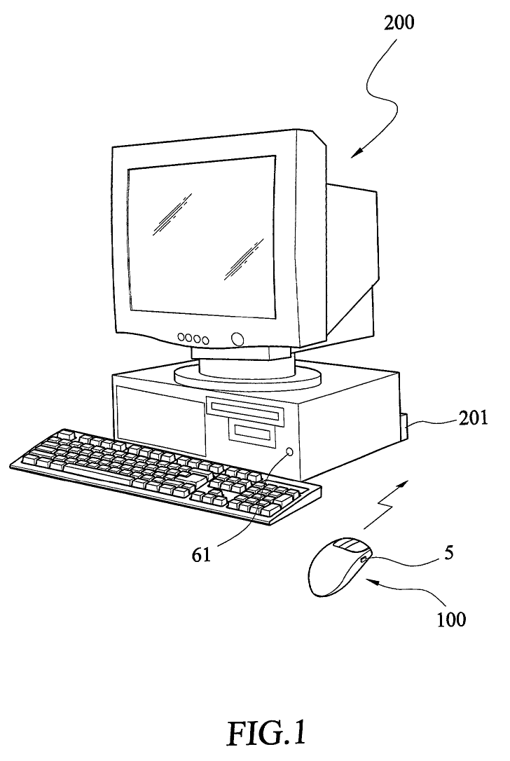

According to the present invention, there is provided a computer device with remote control module, and a first embodiment of which is shown in FIG. 1. As shown, the computer device with a remote control module mainly includes a wireless computer peripheral device internally equipped with a power switch remote control signal generator for generating and transmitting a power switch remote control signal, which is received by a remote control signal reception module included in the computer device for controlling a power supply condition of a power supply system of the computer device. In the embodiment illustrated in FIG. 1, the wireless computer peripheral is a wireless mouse 100, which is structurally similar to a general mouse and is adapted to generate a cursor movement signal on a screen of the computer device that is generally denoted by reference number 200, so as to control the movement of the cursor and the selection function thereof. More specifically, the wireless mouse 100 employs infrared-based or radio-frequency-based wireless signal transmission technology to transmit control signals and key function signals from the mouse 100 to the computer 200 via a wireless data reception unit 201.

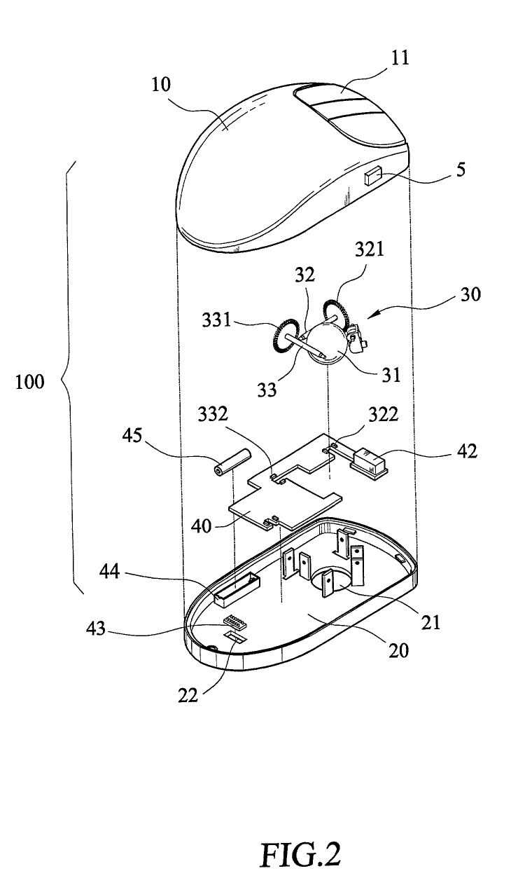

Please refer to FIG. 2 that is an exploded perspective view of the wireless mouse 100 of the present invention. As shown, the wireless mouse 100 includes an upper case 10 equipped with at least one function key 11, and a lower case 20 matching with the upper case 10 to provide an internal space between them for accommodating a mouse control mechanism 30 and a printed circuit board 40 therein. The lower case 20 is provided with an open area 21, above which the mouse control mechanism 30 is located. The lower case 20 of the wireless mouse 100 is also provided with a battery compartment 44 for a battery 45 to mount therein.

The mouse control mechanism 30 includes a ball 31, an X-axis wheel post 32 having an X-axis encoding wheel 321 connected to an end thereof, and a Y-axis wheel post 33 having a Y-axis encoding wheel 331 connected to an end thereof. An X-axis photoelectric detector 322 mounted on the printed circuit board 40 detects rotations of the X-axis encoding wheel 321 to generate X-direction cursor movement signals, and a Y-axis photoelectric detector 332 mounted on the printed circuit board 40 detects rotations of the Y-axis encoding wheel 331 to generate Y-direction cursor movement signals.

A remote control switch 5 is provided on the wireless mouse 100 at a suitable position for remotely controlling the power-on and the power-off of the computer 200.

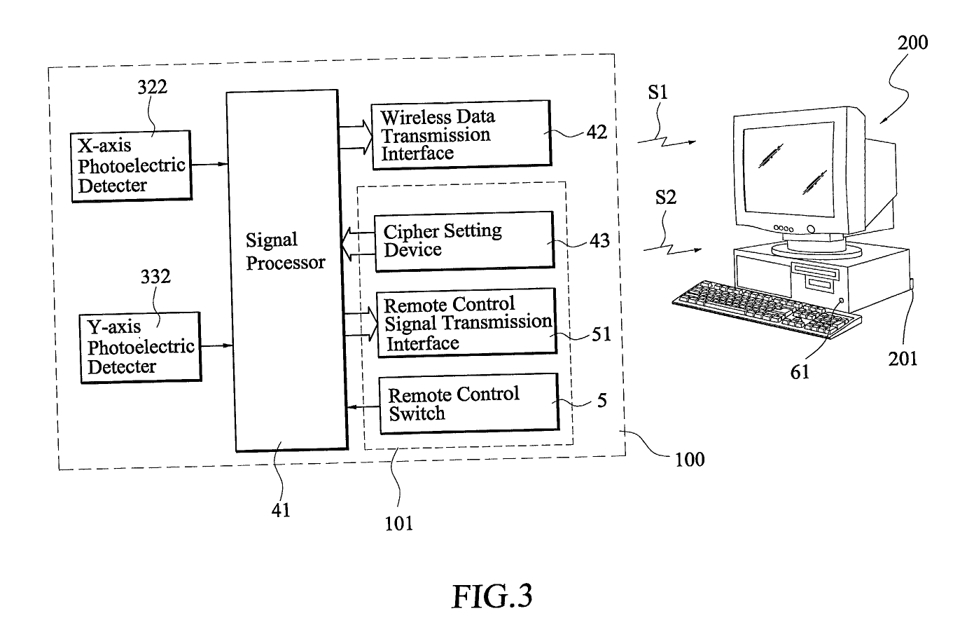

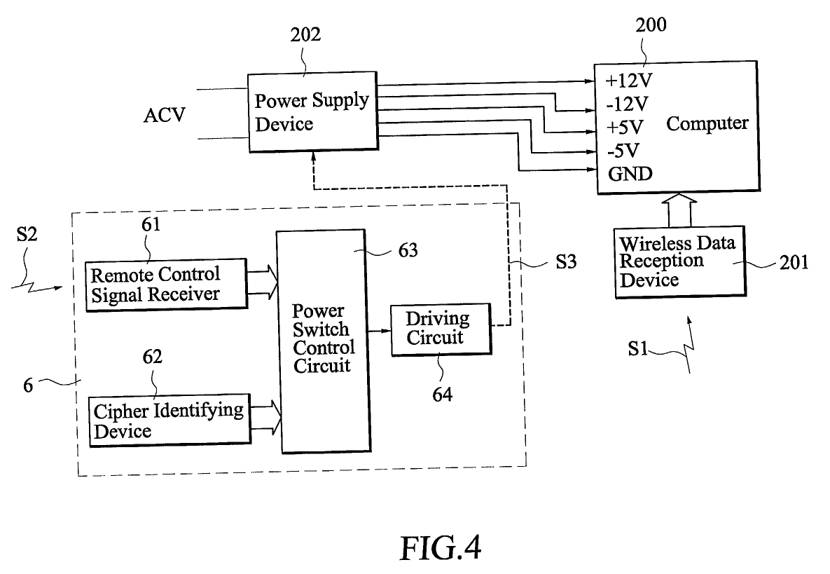

FIG. 3 is a control circuit diagram showing the electric connection of the wireless mouse 100 to the computer 200, and FIG. 4 is a control circuit diagram for the computer end 200 of the present invention. In the control circuit of the wireless mouse 100, there are included a signal processor 41 for receiving and processing X-position and Y-position signals detected by the X-axis photoelectric detector 322 and the Y-axis photoelectric detector 332, respectively, and a wireless data transmission interface 42 for transmitting a wireless mouse data signal S1, which has been processed by the signal processor 41, to the wireless data reception unit 201 on the computer 200 for receiving by the computer 200.

The wireless data transmission interface 42 and the wireless data reception unit 201 are structured to transmit the wireless mouse data signal S1 via infrared (IR) or radio frequency (RF). The lower case 20 of the wireless mouse 100 is provided at a predetermined position with an opening 22, into which a cipher setting means 43 is mounted.

The wireless mouse 100 also includes a power switch remote control signal generator 101 that includes a remote control switch 5, a remote control signal transmission interface 51, and a cipher setting means 43. The cipher setting means 43 allows a user to set a cipher for the computer device of the present invention.

When the remote control switch 5 is pushed by a user, it generates a power switch remote control signal and sends the signal to the signal processor 41. On receipt of the power switch remote control signal from the remote control switch 5, the signal processor 41 generates a power switch remote control signal S2 containing the cipher set by the user through the cipher setting means 43, and the signal S2 is transmitted via the remote control signal transmission interface 51 to a remote control signal reception module 6 in the computer 200.

The remote control signal reception module 6 includes a remote control signal receiver 61, a cipher identifying device 62, a power switch control circuit 63, and a driving circuit 64. The remote control signal receiver 61 may be located at a front panel of the computer 200 or directly included in the wireless data reception unit 201.

The power switch remote control signal S2 received by the remote control signal receiver 61 is first sent to the power switch control circuit 63, at where the received signal S2 is checked by the cipher identifying device 62. When the received signal S2 is verified to contain a correct cipher, the driving circuit 64 sends out a power switch driving signal S3 to control a power supply system 202 to supply an operating power needed by the computer 200. The operating power may include different voltage levels, including DC +12V, −12V, +5V, −5V, ground (GND), etc.

In another embodiment of the present invention, the function key 11 on the wireless mouse 100 is used as the means for remotely controlling the power switch of the computer 200. This embodiment could be easily implemented simply by modifying a control program for the signal processor 41 in the wireless mouse 100.

There are different designs for powering off the computer 200 through the remote control switch 5. For example, the computer 200 could be remotely powered off by pushing the remote control switch 5 only once, continuously pushing the switch 5 twice, or pushing the remote control switch 5 once and responding to a prompt on the screen of the computer 200 to confirm the powering off, in order to ensure safe storage of data in the computer 200.

In actual implementation of the present invention, the computer 200 is not necessarily associated with a wireless mouse to achieve the remote power-on and power-off of the computer 200. A wireless keyboard, a wireless rocker, or other types of wireless computer peripherals may also be employed Moreover, a RF channel switching function may be included in the present invention to avoid interference of waves when multiple wireless mice are used.

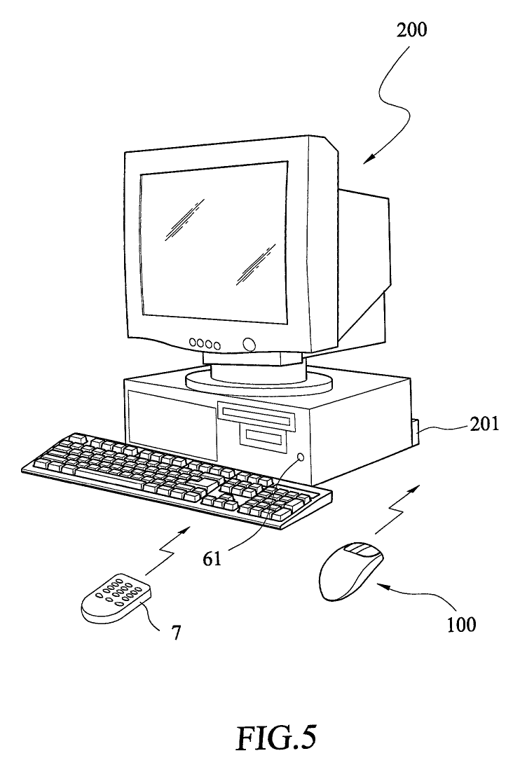

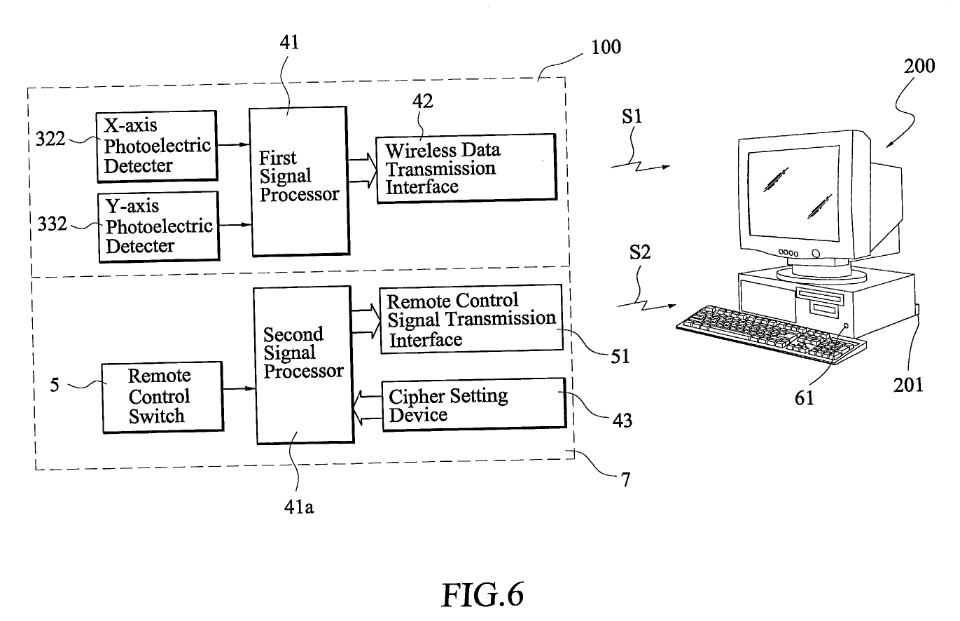

FIG. 5 is a perspective view showing a relative positions of a wireless mouse and a computer device according to a second embodiment of the present invention. FIG. 6 is a control circuit diagram of the wireless mouse having a remote-control function of the second embodiment of the present invention. In this embodiment, a standard wireless mouse 100 is provided to generate a wireless mouse data signal S1 to the computer 200. The standard wireless mouse 100 includes a first signal processor 41 for receiving and processing a X-position and Y-position signals detected by a X-axis photoelectric detector 322 and a Y-axis photoelectric detector 332. A wireless data transmission interface 42 is used for transmitting the wireless mouse data signal S1 to the wireless data reception unit 201 on the computer 200.

A wireless remote control unit 7 is further provided to generate a power switch remote control signal S2 to the computer 200. The wireless remote control unit 7 includes a remote control switch 5, a second signal processor 41 a, a remote control signal transmission interface 51, and a cipher setting means 43. The wireless data reception unit 201 of this embodiment is same to that of the previous embodiment as shown in FIG. 4.

When the remote control switch 5 is pushed by a user, it generates a power switch remote control signal and sends the signal to the second signal processor 41a. On receipt of the power switch remote control signal from the remote control switch 5, the second signal processor 41a generates a power switch remote control signal S2 containing the cipher set by the user through the cipher setting means 43, and the signal S2 is transmitted via the remote control signal transmission interface 51 to the remote control signal receiver 61 on the computer 200.

The present invention has been described with some preferred embodiments thereof and it is understood that many changes and modifications in the described embodiment can be carried out without departing from the scope and the spirit of the invention that is intended to be limited only by the appended claims.

What is claimed is:

1. A computer device with a wireless computer peripheral for generating and transmitting a power switch remote control signal to a remote control signal reception module coupled to the computer for controlling a power supply device of the computer; the wireless computer peripheral comprising:
a remote control switch provided on the remote control unit to be manually operated by a user to generate a remote control signal;
a cipher setting means for setting at least one cipher;
a signal processor electrically connected to the remote control switch and the cipher setting means for receiving the remote control signal generated by the remote control switch when a user pushes the remote control switch, receiving a cipher set through the cipher setting means, and generating a power switch remote control signal containing the cipher set through the cipher setting means on receipt of the remote control signal from the remote control switch; and
a remote control signal transmission interface for transmitting the power switch remote control signal generated by the signal processor; and
the remote control reception module comprising a remote control signal receiver, a cipher identifying device, and a power switch control circuit;
the remote control signal receiver receiving the power switch remote control signal transmitted by the wireless remote control unit;
the cipher identifying device being electrically connected to the power switch control circuit for identifying the cipher set via the cipher setting means; and
the power switch control circuit being electrically connected to the remote control signal receiver and adapted to generate a power switch driving signal when the remote control signal receiver receives a power switch remote control signal from the wireless computer peripheral and the received power switch remote control signal is identified by the cipher identifying device as a signal containing a correct cipher; and the power switch driving signal generated by the power switch control circuit being used to drive the power supply device of the computer to supply or not to supply power to the computer.

2. The computer device with remote control module as claimed in claim 1, wherein the remote control signal transmission interface is an infrared (IR) transmission interface.

3. The computer device with remote control module as claimed in claim 1, wherein the remote control signal transmission interface is a radio-frequency (RF) transmission interface.

4. The computer device with remote control module as claimed in claim 1, wherein the wireless computer peripheral is a wireless mouse.

5. A computer device with a wireless remote control unit for generating and transmitting a power switch remote control signal to a remote control signal receiver coupled to the computer for controlling a power supply device of the computer; the wireless remote control unit comprising:
a remote control switch provided on the remote control unit to be manually operated by a user to generate a remote control signal;
a cipher setting means for setting at least one cipher;
a signal processor electrically connected to the remote control switch and the cipher setting means for receiving the remote control signal generated by the remote control switch when a user pushes the remote control switch, receiving a cipher set through the cipher setting means, and generating a power switch remote control signal containing the cipher set through the cipher setting means on receipt of the remote control signal from the remote control switch; and
a remote control signal transmission interface coupled to the signal processor for transmitting the power switch remote control signal generated by the signal processor; and
the remote control reception module comprising a remote control signal receiver, a cipher identifying device, and a power switch control circuit:
the remote control signal receiver receiving the power switch remote control signal transmitted by the wireless remote control unit;
the cipher identifying device being electrically connected to the power switch control circuit for identifying the cipher set via the cipher setting means; and
the power switch control circuit being electrically connected to the remote control signal receiver and adapted to generate a power switch driving signal when the remote control signal receiver receives a power switch remote control signal from the wireless remote control unit and the received power switch remote control signal is identified by the cipher identifying device as a signal containing a correct cipher; and the power switch driving signal generated by the power switch control circuit being used to drive the power supply device of the computer to supply or not to supply power to the computer.

6. The computer device with remote control module as claimed in claim 5, wherein the remote control signal transmission interface is an infrared (IR) transmission interface.

7. The computer device with remote control module as claimed in claim 5, wherein the remote control signal transmission interface is a radio-frequency (RF) transmission interface.

8. The computer device with remote control module as claimed in claim 5, wherein the wireless remote control unit is mounted in a wireless mouse.
